(19) United States
(12) Patent Application Publication
(10) Pub. No.: US 2018/0125301 A1
(43) Pub. Date: May 10, 2018

(54) HAND OPERATED DUAL CHAMBER GRINDER

(71) Applicant: Lifetime Brands, Inc., Garden City, NY (US)

(72) Inventors: Steven C. Cozzolino, New York, NY (US); Cody Stonerock, Brooklyn, NY (US)

(21) Appl. No.: 15/347,338

(22) Filed: Nov. 9, 2016

(51) Int. Cl. A47J 42/46; A47J 42/04

(52) U.S. Cl. CPC A47J 42/46; A47J 42/04

(57) ABSTRACT

A single hand operated dual chamber grinder has an actuation mechanism that is in mechanical connection with a chamber selection mechanism. A user selects the desired chamber (e.g., desired spice), using the chamber selection mechanism. Once selected, and upon actuation motion, a grinding assembly specific to the selected chamber is engaged and activated.

### BACKGROUND

### 1. Technical Field

The present principles relate to manually operated spice grinders. More particularly, it relates single hand actuated dual chamber spice grinder.

### 2. Related Art

Manually operated spice grinders are often found in a kitchen environment, and are heavily used in food preparation and food service. Most commonly known and used spice grinders are pepper grinders. These grinders have a top portion that is rotated causing a grinding action and a spice/pepper output at the bottom of the same. These grinders are single spice grinders as they only have one chamber for retaining one spice and one grinding mechanism.

Recently, there has been a trend toward salt grinders being used in addition to the known pepper grinder. These too have the same single chamber and single grinding mechanism limitations as that of the pepper grinder.

### SUMMARY

According to an implementation, the hand operated dual chamber spice grinder includes an actuation mechanism, a chamber selection mechanism in mechanical communication with the actuation mechanism; a first chamber grinding assembly, and a second chamber grinding assembly. The chamber selection mechanism is configured to enable selection and thereby connecting the actuation mechanism to either the first chamber grinding assembly or the second chamber grinding assembly.

In accordance with another implementation, the hand operated dual chamber spice grinder includes an actuation mechanism, a chamber selection mechanism in mechanical communication with the actuation mechanism, a first chamber grinding assembly and a second chamber grinding assembly.

The chamber selection mechanism includes an idle gear carousel, a first chamber specific idle gear, a second chamber specific idle gear, and a selection button for selecting which chamber is to be used. A first chamber specific idle gear is positioned on an upper surface of the idle gear carousel and a first chamber specific idle gear positioned on a lower surface of the idle gear carousel. A second chamber specific idle gear is positioned on an upper surface of the idle gear carousel and a second chamber specific idle gear positioned on a lower surface of the idle gear carousel. The selection button positions the idle gear carousel such that the first or second chamber specific lower idle gear engages with its corresponding first chamber grinding assembly or second chamber grinding assembly, respectively, in response to the users selection.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is s perspective view of the single hand actuated dual chamber spice grinder, according to an implementation of the present principles;

FIG. 2 is a schematic view of the internal workings of the single hand actuated dual chamber spice grinder, according to an implementation of the present principles;

FIG. 3 is a perspective view of the single hand actuated dual chamber spice grinder showing one fill door open, according to an implementation of the present principles;

FIG. 4 is a bottom perspective view of the single hand actuated dual chamber spice grinder, according to an implementation of the present principles;

FIG. 5 is a side view of the single hand actuated dual chamber spice grinder, according to an implementation of the present principles;

FIG. 6 is a cross-sectional view of the single hand actuated dual chamber spice grinder, taken along line A-A of FIG. 5, according to an implementation of the present principles;

FIG. 7 is a cross-sectional view of the single hand actuated dual chamber spice grinder, taken along line A-A of FIG. 5, according to an implementation of the present principles;

FIG. 8 is a side view of the single hand actuated dual chamber spice grinder, according to an implementation of the present principles;

FIG. 9 is a cross-sectional view of the single hand actuated dual chamber spice grinder, taken along line A-A of FIG. 8, according to an implementation of the present principles;

FIG. 10 is a cross-sectional view of the single hand actuated dual chamber spice grinder, taken along line A-A of FIG. 8, according to an implementation of the present principles;

FIG. 11 is a top view of the single hand actuated dual chamber spice grinder, according to an implementation of the present principles;

FIG. 12 is a cross-sectional view of the single hand actuated dual chamber spice grinder, taken along line C-C of FIG. 11;

FIG. 13 is an exploded perspective view of the single hand actuated dual chamber spice grinder, according to an implementation of the present principles; and

FIG. 14 is an enlarged view of the internal gear housing of the single hand actuated dual chamber spice grinder, according to an implementation of the present principles.

### DETAILED DESCRIPTION

The present principles are directed to manually operated spice grinders. More specifically, a single hand actuated dual chamber spice grinder having the ability to selectively change the grinding chamber in communication with the hand actuator.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

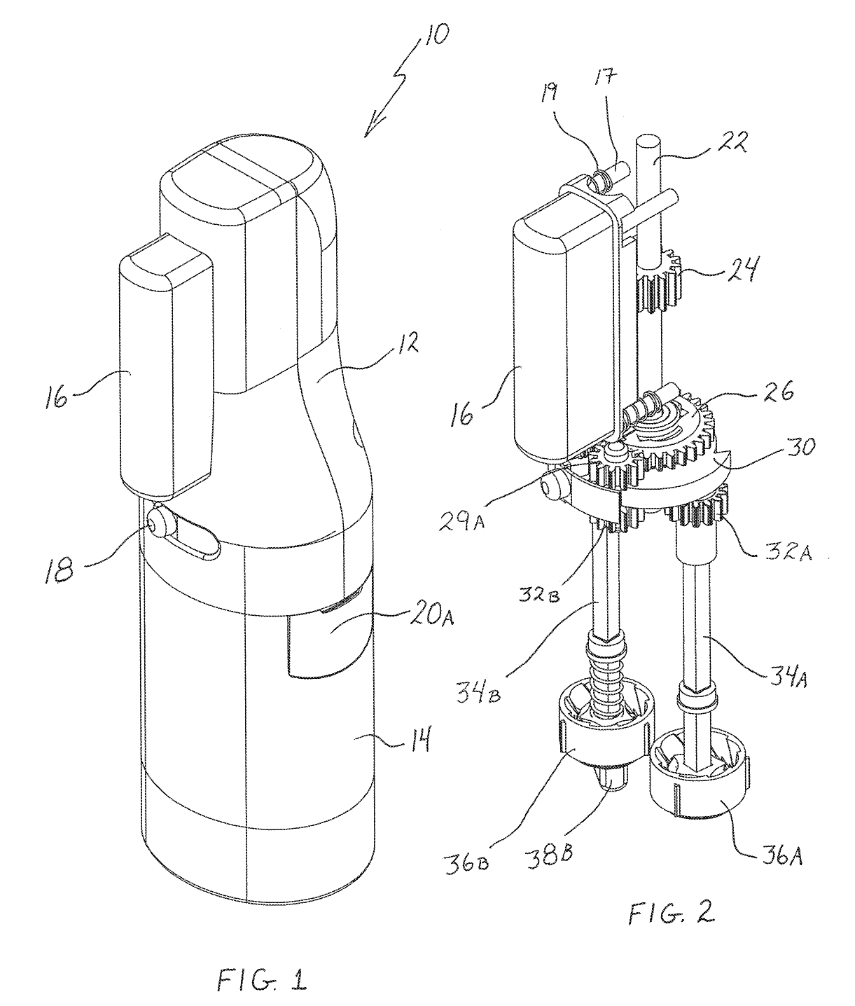

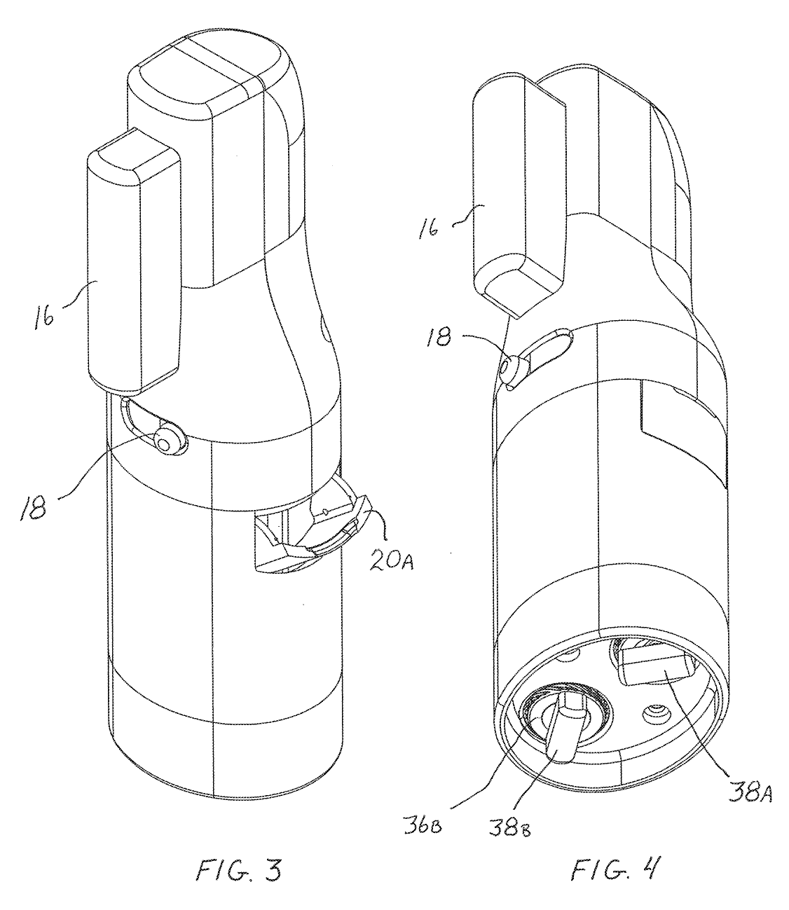

Referring to FIG. 1 there is shown the single hand actuated dual chamber spice grinder 10 according to a preferred implementation of the present principles. The grinder 10 has an upper housing 12 and a lower housing 14 where the dual chambers are positioned. An actuation lever 16 on the upper housing is configured to be actuated by a single user hand by laterally engaging the same and pushing it into the housing 12. A selection button 18 selects which of the two chambers (e.g., salt or pepper) will be grinding in response to movement of the actuation lever 16. Fill doors 20A (See FIGS. 1, 3, 5 and 8) and 20B (See FIGS. 5 and 8) provide access to each chamber for filling the spice or material to be ground in the same.

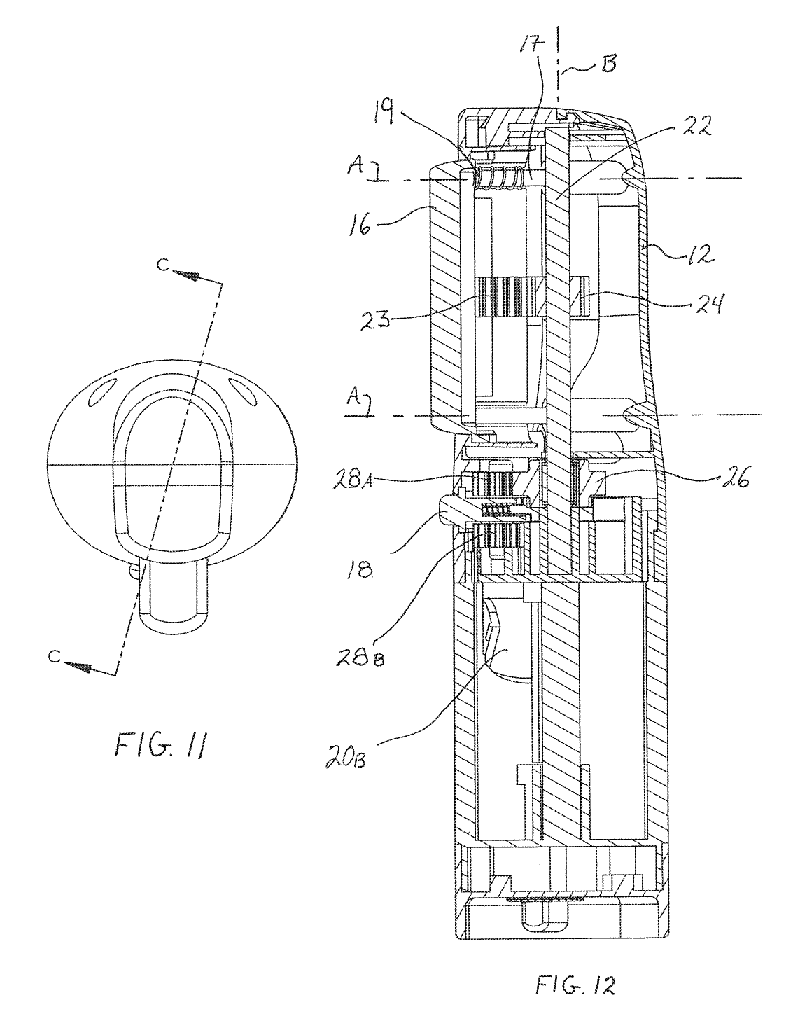

Referring to FIGS. 2 and 12, there is shown schematic representations of the internal workings of the grinder 10 according to an implementation of the present principles. The actuation lever 16 is mounted on axles or guide rods 17 which are received into corresponding apertures or openings in the internal side of upper housing 12 (See FIG. 12), such that the lever 16 laterally or axially moves in and out of the upper housing 12 when squeezed and release. The guide rods 17 include one or more springs 19 which bias the lever 16 in the outermost position such that the same is always ready to be used. An upper drive axle 22 includes a pinion gear 24, while the lever 16 includes a rack 23 internally mounted therein such that the squeezing action of the lever causes the rack 23 to engage the pinion 24 and rotate the drive axle 22. In accordance with one implementation, a one way mechanism can be incorporated into the pinion 24, so that the same cannot rotate in an undesired direction.

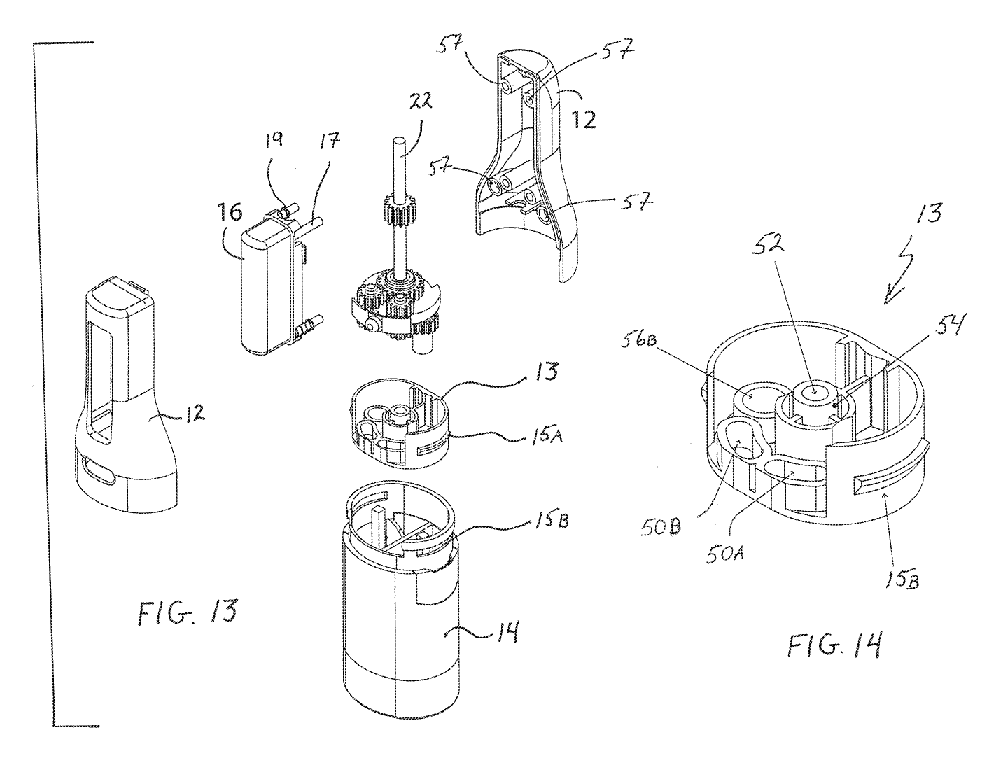

At the base of the drive axle 22 is a driver gear 26, and an idle gear carousel 30. Upper idle gears 28A and 29A are located on the upper surface of idle gear carousel 30, and corresponding lower idle gears 29A and 29B are located on the lower surface of the carousel 30. Channels 50A and 50B located in the internal gear housing 13 (See FIGS. 13 and 14) enable the idle gear carousel 30 to move the respective lower idle gears into and out of contact with the corresponding grinding rod as desired (See FIGS. 7 and 10). In accordance with one implementation, a one way mechanism can be incorporated into the drive gear 26 to force exclusive one way rotation of the same. As will be described in further detail below, the position of the selection button 18 determines which idle gear will mesh with which of the two grinding gears 32A or 32B and thus which corresponding rod 34A or 34B will be actuated.

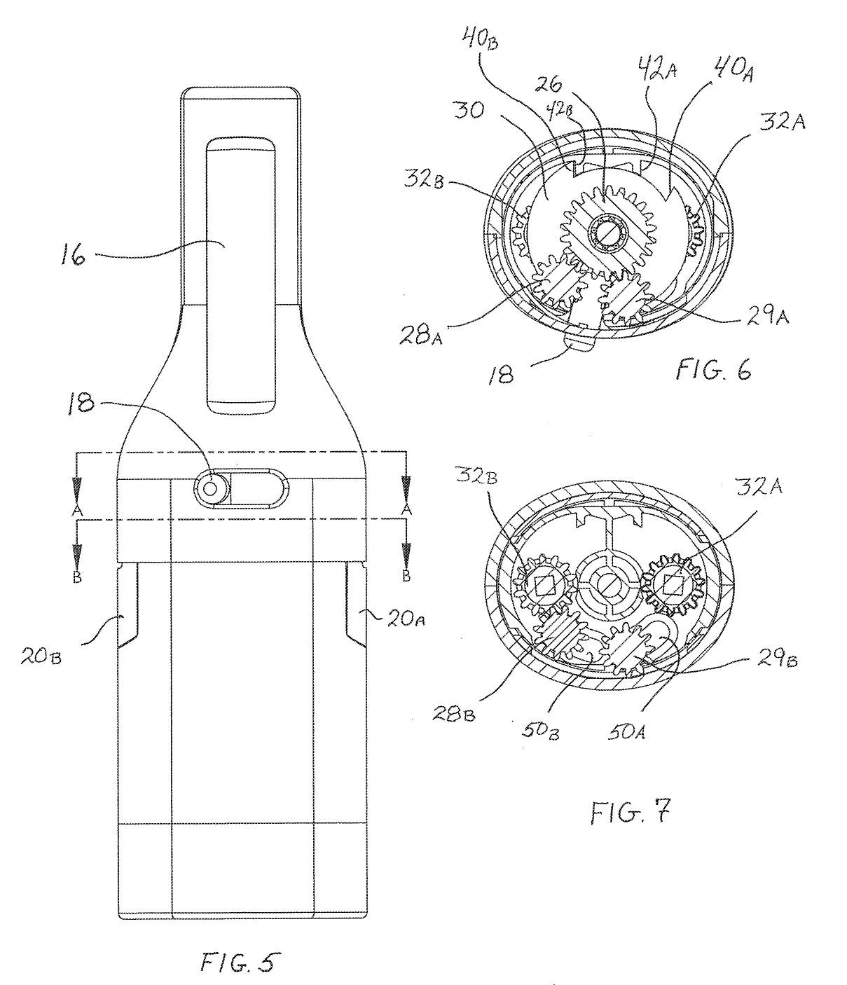

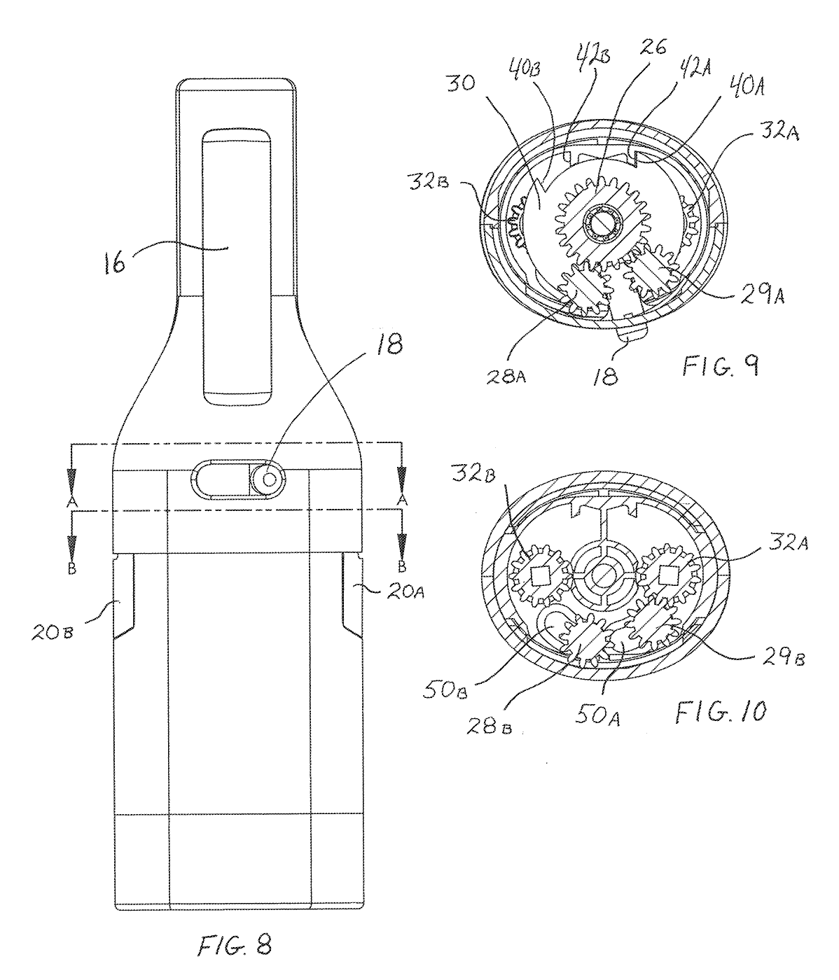

Each chamber of the grinder includes a grinder rod 34A and 34B, respectively, each having a grinder gear 32A and 32B, respectively. At the base of each grinder rod is a grinder cone assembly 36A and 36B which controls the coarseness of the ground material using known techniques, such as a spring loaded end with an adjustment knob 38 so as to adjust the position of the grinder cone within the respective opening it sits in the housing (See FIG. 4). Those of skill in the art will appreciate that the surfaces of the grinder gears 32 can be modified in accordance with a desired grinding capability, and they clearly do not need to the be the same. For example, rather than designating chambers for different spices (e.g., salt and pepper), the chambers can be designated based on coarseness of the ground. Thus, one chamber can produce a find grind while the other could be designated for a more coarse grind.

Referring to FIGS. 2 and 5-7, when the selection button 18 is positioned to the left (which selects the left chamber for grinding) this rotates the idle gear carousel 30 to one operating position where a stop 40B on the same meets with a wall 42B in the housing. In this position, the lower idle gear 28B engages or meshes with the grinder gear 32B. Thus, when the activation lever 16 is squeezed by a user, the rack 23 will engage pinion 24, rotate drive axle 22 and thus drive gear 26, thereby rotating the selected idle gear 28B and engage the grinder gear 32B causing the grinding rod 34B to rotate. The user selects how much spice to grind by controlling their hand squeezing action of the lever 16. As is shown in FIG. 6, the drive gear 26 is always in contact with both upper idle gears 28A and 29A. It is the position of the selection button 18 that determines which of the lower idle gears 28B or 29B engage its corresponding grinding gear rod.

When the user decides to change the spice chamber, the selection button 18 is depressed (against its outward spring bias) and moved to the right (See FIGS. 8-10). As shown, this action causes the idle gear carousel 30 to move causing lower idle gear 29B to engage the grinder gear 32A and thus rotate the grinder rod 34A during actuation of the hand lever 16.

FIG. 12 shows a cross section of the grinder according to one implementation. Here you can see the spring loaded selection button 18. As further shown, the actuating lever 16 is supported by two or more laterally extending posts 17 which, as described above, are received into openings 57 in housing 12 (See FIG. 13). One or more springs 19 are positioned around the posts 17 and provide the spring back or spring loaded action of the lever 16 such that after each squeeze, the same returns to a ready, to be used, position. As will be appreciated by the cross section of FIG. 12, the lateral axis A on which the posts 17 extend and retract, is perpendicular to the rotation axis B of the drive axle 22, and grinder rods 34.

As will be appreciated from the above, the dual chamber hand operated grinder has an actuation mechanism made up of the lever 16 and support rod 17, along with the rack and pinion 24 configured to engage and rotate the drive axle 22. The lateral actuation of the hand lever 16 rotates the drive axle 22 as desired. Through the implementation of the chamber selection mechanism defined by the selection button 18, the idle gear carousel 30 and the corresponding idle gears 28 and 29, the rotation of the drive axle 22 is thereby translated to the selected grinder rod 34 and thus the desired spice chamber. The grinding mechanisms for each chamber are made up of the grinder rods 34 with connected grinding cones 36. The position of the grinding cones 36, and thus the coarseness of the grind, can be adjusted by the handles 38 and the spring loaded aspects of the same.

FIG. 13 shows an exploded view of the hand grinder according to an implementation of the present principles. This view reveals the internal gear housing 13 which include a flange or protrusion 15A that is received into a slot 15B in the lower housing 14 in a snap fit type configuration. FIG. 14 shows an enlarged view of the internal gear housing 13. This internal gear housing includes the slots or lower guides 50A and 50b for the corresponding gears 28B and 29B, in addition to a lower bearing 52 for shaft 22. The outer surface 54 of the lower bearing 52 operates as the axle for the idle gear 30. Also shown is the bearing 56B for the grinder gear 32B. The other bearing 56A for the grinder gear 56B is not visible in this view.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A hand operated dual chamber spice grinder comprising:
an actuation mechanism;
a chamber selection mechanism in mechanical communication with the actuation mechanism;
a first chamber grinding assembly; and
a second chamber grinding assembly,
said chamber selection mechanism being configured to enable selection and thereby connection of the actuation mechanism to either the first chamber grinding assembly or the second chamber grinding assembly.

2. The hand operated dual chamber spice grinder of claim 1, wherein said actuation mechanism comprises:
an actuation lever configured to be squeezed by one hand;
a gear system connected to the actuation lever; and
a drive assembly connected to the gear system, wherein squeezing of the actuation lever engages said gear system to rotate said drive assembly.

3. The hand operated dual chamber spice grinder of claim 1, wherein said chamber selection mechanism comprises:
an idle gear carousel;
first and second chamber specific idle gears positioned on both an upper surface and lower surface of the idle gear carousel; and
a selection button actuated by a user and configured to position the idle gear carousel such that the chamber specific idle gear on the lower surface of the idle gear carousel engages with its corresponding first chamber grinding assembly or second chamber grinding assembly, respectively in response to the users selection.

4. The hand operated dual chamber spice grinder of claim 1, wherein said first chamber grinding assembly comprises a first grinding rod having a first grinding gear positioned at a top thereof, and a first grinding cone positioned at a bottom thereof, said first grinding gear being engaged when the first chamber is selected by the selection mechanism.

5. The hand operated dual chamber spice grinder of claim 1, wherein said second chamber grinding assembly comprises a second grinding rod having a second grinding gear positioned at a top thereof, and a second grinding cone positioned at a bottom thereof, said second grinding gear being engaged when the second chamber is selected by the selection mechanism.

6. The hand operated dual chamber spice grinder of claim 2, wherein the drive assembly comprises a drive axle and a drive gear positioned at a base of the drive axle, the gear system comprising a rack and pinion, where the pinion is positioned on the drive axle and rack is part of the actuation lever, such that movement of the actuation lever causes rotation of the drive axle.

7. The hand operated dual chamber spice grinder of claim 6, wherein said chamber selection mechanism comprises:
an idle gear carousel positioned beneath the drive gear;
a first chamber specific upper idle gear positioned on an upper surface of the idle gear carousel;
a second chamber specific upper idle gear positioned on the upper surface of the idle gear carousel; said first and second upper idle gears being engaged with the drive gear at all times;
a first chamber specific lower idle gear positioned on a lower surface of the idle gear carousel;
a second chamber specific lower idle gear positioned on the lower surface of the ideal gear carousel; and
a selection button actuated by a user and configured to position the idle gear carousel such that the first or second chamber specific idle gear on the lower surface of the idle gear carousel engages with its corresponding first chamber grinding assembly or second chamber grinding assembly, respectively, in response to the users selection.

8. A hand operated dual chamber spice grinder comprising:
an actuation mechanism;
a chamber selection mechanism in mechanical communication with the actuation mechanism, the chamber selection mechanism comprising:
an idle gear carousel;
a first chamber specific idle gear positioned on an upper surface of the idle gear carousel and a first chamber specific idle gear positioned on a lower surface of the idle gear carousel;
a second chamber specific idle gear positioned on an upper surface of the idle gear carousel and a second chamber specific idle gear positioned on a lower surface of the idle gear carousel;
a selection button actuated by a user and configured to position the idle gear carousel such that the first or second chamber specific lower idle gear engages with its corresponding first chamber grinding assembly or second chamber grinding assembly, respectively, in response to the users selection.
a first chamber grinding assembly; and
a second chamber grinding assembly,
said chamber selection mechanism being configured to enable selection and thereby connection of the actuation mechanism to either the first chamber grinding assembly or the second chamber grinding assembly.

9. The hand operated dual chamber spice grinder of claim 8, wherein said actuation mechanism comprises:
an actuation lever configured to be squeezed by one hand;
a gear system connected to the actuation lever; and
a drive assembly connected to the gear system, wherein squeezing of the actuation lever engages said gear system to rotate said drive assembly.

10. The hand operated dual chamber spice grinder of claim 8, wherein said first chamber grinding assembly comprises a first grinding rod having a first grinding gear positioned at a top thereof, and a first grinding cone positioned at a bottom thereof, said first grinding gear being engaged when the first chamber is selected by the selection mechanism.

11. The hand operated dual chamber spice grinder of claim 8, wherein said second chamber grinding assembly comprises a second grinding rod having a second grinding gear positioned at a top thereof, and a second grinding cone positioned at a bottom thereof, said second grinding gear being engaged when the second chamber is selected by the selection mechanism.
